(19) United States
(12) Patent Application Publication
(10) Pub. No.: US 2002/0142176 A1
(43) Pub. Date: Oct. 3, 2002

(54) Coating acting as a lubricant and method for its manufacture

(76) Inventor: Thomas Brinz, Bissingen Unter Der Teck (DE)

Correspondence Address: KENYON & KENYON, ONE BROADWAY, NEW YORK, NY, 10004, US

(21) Appl. No.: 10/053,966

(22) Filed: Jan. 22, 2002

(30) Foreign Application Priority Data
Jan. 19, 2001 (DE) 101 02 238.7-43

(51) Int. Cl. B32B 9/04; B05D 1/36; B05D 7/00

(52) U.S. Cl. 428/447; 427/407.1; 428/500

(57) ABSTRACT

A coating with a low coefficient of friction on a body, with at least its coated surface zones containing polymers, is provided. A method for producing the coating is provided. The coating acts as a lubricant for a body of this type. The coating, being bonded to the surface of the body at least by intermolecular forces and having LC properties, is provided. The method for producing a coating of this type, in which compounds having at least one mesogenic group are produced, and in which a plurality of components are bonded, at least in some areas, to the surface of a body of this type either directly or via the primary chain of a polymer, is also provided.

### BACKGROUND INFORMATION

The present invention relates to a coating of a body, which acts as a lubricant, with at least the coated surface containing polymers, and a method for manufacturing the coating.

### BACKGROUND INFORMATION

Good lubrication between two contacting surfaces which move relative to one another reduces the energy expended during movement and thus has economic and ecological benefits. In addition, reducing the amount of energy to be expended correspondingly results in a smaller design of the drive units, so that they occupy less space and are more cost-effective.

Low-viscosity liquid-crystalline fluids are known as low-viscosity lubricants with low coefficients of friction. However, they are unsuitable for use as lubricants for windshield wipers because the lubricant smears the windshield. The wiper blades in the windshield wipers, which are usually made of rubber or rubber-like materials, are therefore treated with chlorine and subsequently graphitized to make them slide more smoothly. Wiper blades which are coated with polyamide are also known. While these measures improve the coefficients of friction, they are still unsatisfactory.

### SUMMARY OF THE INVENTION

The object of the present invention is to provide a coating having a low coefficient of friction on a body, with at least the coated surface zones of this body containing polymers, as well as an easy method for manufacturing the coating.

The coating according to the present invention uses the lubricating action of materials with liquid-crystal properties, while minimizing abrasion (i.e., the amount of material that reaches the surface to be wiped by the coated surface) so that significant dirt accumulation does not occur. The method for producing the coating combines process steps that may be carried out economically using ordinary apparatus.

It is useful to design the coating so that a multiplicity of side chains, each of which contains at least one mesogenic group, extends from the surface, the side chains may be advantageously attached to the body surface or to the primary chain of a polymer molecule and the latter, in turn, may be attached to the body surface. A side chain in this case is a molecule radical that branches off from the primary chain of a polymer (which may also form part of the body surface) and is attached to the polymer by chemical bonding or by intermolecular forces. The above-mentioned side chains may be advantageous because they may be aligned in a particularly effective manner in the direction of movement. Attaching the side chains to a polymer by chemical bonds may result in LC side chain polymers. When part of the body or attached to the body by chemical bonding, these polymers may be subject to only minor abrasion.

The side chains may be preferably attached via an anchoring group.

It may be useful to provide one mesogenic group per side chain and to add a spacer to the end of the mesogenic group facing the anchoring group, and it may be even more useful to provide at least two mesogenic groups per side chain which are arranged consecutively as viewed from the anchoring group and to provide spacers between the anchoring group and the closest mesogenic group and possibly also between mesogenic groups. Spacers may make it easier to align the mesogenic groups and may facilitate, for example chemically, the adaptation of the anchoring group to the mesogenic group.

It may be advantageous to append an end group to the end of the side chain facing away from the body surface, with this end group having minimal interaction with the surface along which the body slides.

To improve coating service life and effectiveness, it may be advantageous to attach to the body multiple interconnected layers of the polymer provided with side chains.

A good lubricating action may be achieved by having the coating form an LC phase from the group of nematic, smectic, discoid nematic and columnar discotic phases, with the nematic and smectic phases being especially preferred.

The coating according to the present invention may be used to particular advantage if the polymer contained in the body is elastic and, in particular, if the body is a wiper blade.

In manufacturing the coating by polymerization or by chemical grafting of monomers to the primary chain of a polymer, it may be advantageous to carry out reactions such as radical or radiation-initiated polymerization, polycondensation or a polymer-like reaction corresponding to these reactions or vinyl addition.

The advantageous, multilayer coatings according to the present invention may preferably be produced by attaching multiple layers of the produced polymer over one another to the body surface. The layers may be advantageously bonded together by cross-linking their primary chains with each other and possibly by cross-linking the second layer with an adjacent primary chain and with the body surface, or by intermeshing the side chains belonging to adjacent stacked layers like the bristles of two brushes so that they adhere to one another via intermolecular forces.

### BRIEF DESCRIPTION OF THE DRAWINGS

FIG. 1 shows a schematic cross-sectional representation of a body, such as a wiper blade, which is coated with side chains containing mesogenic groups according to the present invention.

FIG. 2a shows a schematic representation of sections of the primary chain of polymers with side chains containing mesogenic groups.

FIG. 2b shows a schematic perspective representation of the primary chains of a polymer with side chains (LC side chain polymer) that form domains with LC properties.

FIG. 3 shows a schematic representation of the structure of a side chain in an advantageous embodiment of the present invention.

FIG. 4 shows a schematic perspective representation of a wiper blade in action, whose narrow side is coated according to the present invention.

FIG. 5a shows a schematic cross-sectional representation of an embodiment of the coating in which the side chains are bonded to the body with spacers of different lengths.

FIG. 5b shows a schematic representation of an alternative to the coating illustrated in FIG. 5a, in which side chains, each containing two mesogenic groups, are bonded to the body.

FIG. 6a shows an idealized perspective representation of cross-linked layers of LC side chain polymers.

FIG. 6b shows a realistic cross-sectional representation of cross-linked layers of LC side chain polymers.

FIG. 7 shows a schematic cross-sectional representation of two layers of LC side chain polymers, with the layers being bonded together by intermolecular forces between the side chains.

FIGS. 8a through 8d show liquid crystalline phases, which can be advantageously used in the coating according to the present invention.

FIGS. 9a through 9d show schematic perspective representations of smectic phases according to particularly advantageous embodiments of the coating according to the present invention.

### DETAILED DESCRIPTION

The present invention is described below primarily on the basis of wiper blades coated according to the present invention. In the interest of clarity, it is to be noted that, while the present invention may be used to particular advantage in wiper blades, and while the present invention may be especially effectively illustrated on the basis of this embodiment, alternative embodiment are possible.

FIG. 1 shows a body 1, such as a wiper blade, to which are attached side chains 2, each having one mesogenic group 3. At least the surface of body 1, to which the side chains are attached, contains polymers.

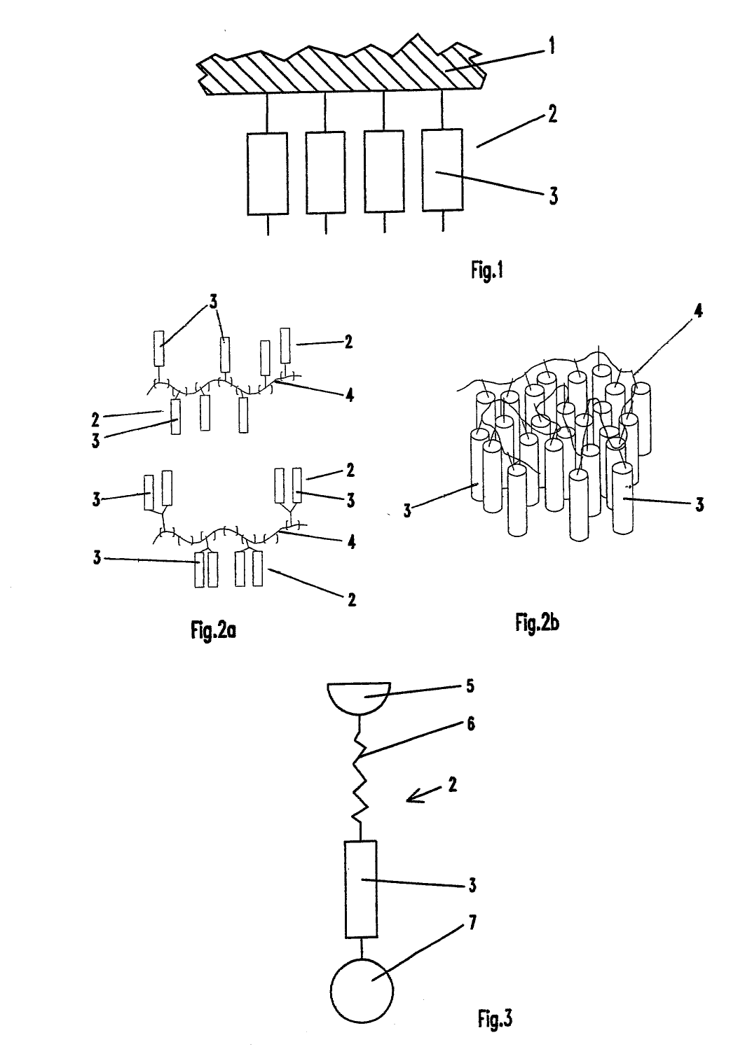

FIG. 2a shows sections of primary chain 4 of side chain polymers, with side chains 2 containing at least one mesogenic group 3 being bonded to the primary chain. As shown in FIG. 2b, side chain polymers of this type may form domains with LC properties and may therefore be used according to the present invention. The areas of the primary chain where the side chains are grafted are preferably freely rotatable so that the side chains branch off in the same direction (FIG. 2b) or in different directions (FIG. 2a).

FIG. 3 shows a schematic representation of the structure of a side chain 2, which may preferably be used in the structures and is illustrated, for example, in FIGS. 1, 2a and 2b. This side chain may be bonded, via an anchoring group 5, directly to the abradant body, such as a wiper blade, or to the primary chain of a polymer (which, in turn, is bonded to the abradant body) by chemical bonding or by intermolecular forces. A component of the side chain in the present case is mesogenic group 3, which, together with mesogenic groups of other side chains, may develop liquid crystal properties by aligning the mesogenic groups with one another. The mesogenic group may preferably be made of biphenyl, hydrobenzoate, naphthalene derivative or triphenylene radicals. Primarily to facilitate the alignment of the mesogenic groups relative to one another, the anchoring group may be bonded to the mesogenic group by a spacer 6. Alkyl or siloxane groups, which are soft and flexible, may preferably be used as spacers. Depending on the object, such as a glass pane, against which the abradant body rubs, the side chain may preferably have an end group 7 on the end of the mesogenic group facing away from the anchoring group. This end group may, depending on its properties such as polarity, ensure that there is minimal interaction between the side chain and the surface against which the body rubs. An alkyl group that may be partially or entirely fluorinated, may be suitable as the end group if the surface is to be nonpolar, while a CN group may be suitable if the surface is to be polar.

When subjected to friction, the domains undergo alignment, i.e., the side chains become aligned with one another, since the bonds between the side chains are weak. This alignment causes the coefficient of friction of the coated wiper blade to decrease. A bundle of pick-up sticks held in the hand serve as a model to illustrate this effect. If the sticks are aligned so that they form different angles to each other from zero, the sticks “adhere” to each other to a certain degree. If the sticks are aligned parallel with each other, and if the bundle is held vertically, the sticks slip out from the hand holding them. FIG. 4 shows how the wiper blade works in practice. When wiper blade 1 held in a windshield wiper (not shown) is drawn across a pane of glass, such as a windshield, in the direction of arrow 8, side chains 2 of the coating orient themselves with each other, thus reducing the coefficient of friction. This reduction makes it possible to design smaller and less powerful motors for the wiper drive, making them more economical and safer for the environment.

Although the function and basic structure of the coating can be illustrated especially effectively on the basis of a coating in which the mesogenic groups are arranged in a single layer (see above), this arrangement may not be very practical, because the coating is subjected to abrasion. The mesogenic groups may therefore be preferably arranged in multiple layers or at least may be spaced at varying distances from the primary chain. “Multilayer” coatings of this type may be implemented in a variety of ways.

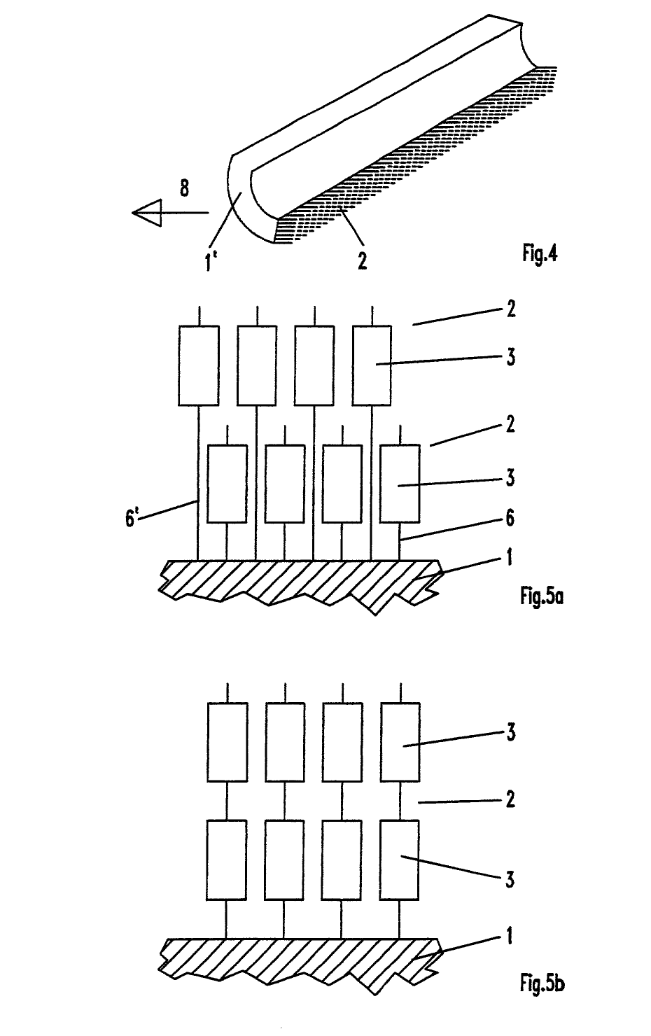

FIG. 5a shows a schematic cross-sectional representation of a coating in which mesogenic groups are positioned in two layers by using two types of side chains 2 that differ from each other in that spacers 6 and 6′, respectively, are of different lengths. According to the alternative shown in FIG. 5b, the mesogenic groups are positioned in two layers by providing two mesogenic groups 3 for each side chain 2. An arrangement of mesogenic groups in more than two layers may be achieved in this manner by using LC primary chain oligomers or LC primary chain polymers as the side chain.

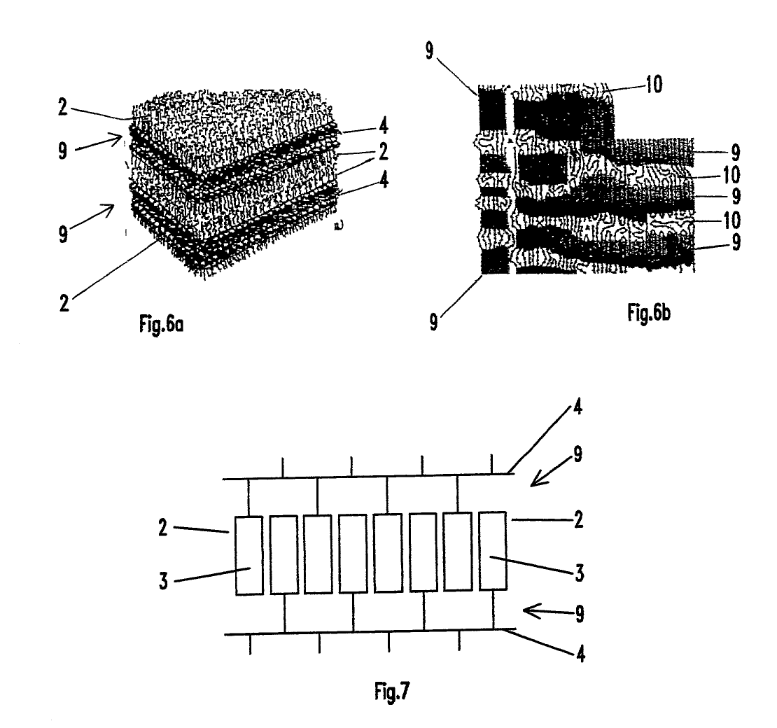

For illustrative purposes, FIG. 6a shows an idealized representation of two layers 9 of LC side chain polymers, each of which may include one primary chain 4 and side chains 2 extending therefrom. The side chains may each contain a mesogenic group or be designed according to the embodiments illustrated in FIGS. 5a and 5b. To extend coating service life, the primary chains may be cross-linked with each other (not illustrated). As shown in FIG. 6b, in reality layers 9 may not be situated precisely parallel one over another, but rather there may be some interruptions, and the ends of the segments may overlap. As further shown in FIG. 6b, there may also be amorphous zones 10 where the mesogenic groups are not aligned with each other. According to the basic design shown in FIGS. 6a and 6b, respectively, coatings may also be produced with more than two layers of LC side chain polymers, making it possible, as in the embodiment described in the following section, to obtain an arrangement of mesogenic groups in a relatively large number of layers.

FIG. 7 shows another type of connection between layers of LC side chain polymers. According to this embodiment, instead of cross-linking primary chains 4, facing side chains 2 of two adjacent PC side chain polymers may be intermeshed like the bristles of two brushes and bonded together by intermolecular forces, such as hydrogen bridges. Although abrasion may be higher in this embodiment than in the embodiments illustrated in FIGS. 6a and 6b, the coefficient of friction may be very low. According to the basic design illustrated on the basis of FIG. 7, it may be possible to produce coatings with more than two layers, with the side chains also being designed according to the embodiments shown in FIGS. 5a and 5b.

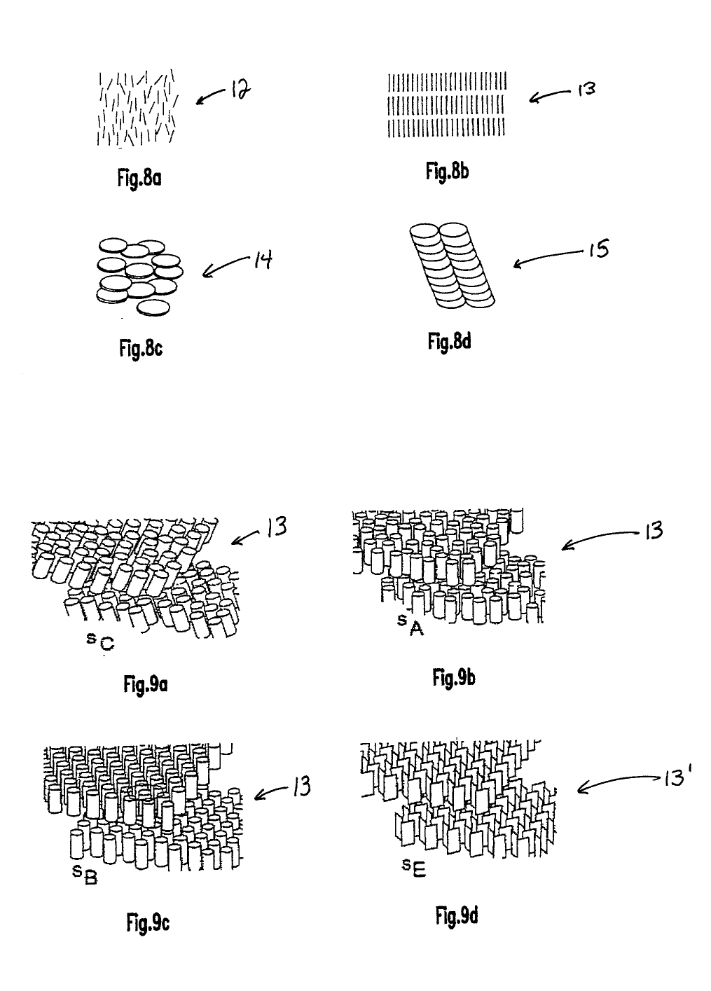

FIGS. 8a through 8d show the liquid crystalline phases that may be usable, according to the present invention, especially for multilayer coatings. In the nematic phase shown in FIG. 8a, the longitudinal axes of mesogenic groups 12 may be arranged in a preferred direction. In the smectic phase shown in FIG. 8b, mesogenic groups 13 may be arranged in layers, and their longitudinal axes may be additionally oriented parallel to each other within the layers. In the discoid nematic phase (see FIG. 8c), more or less plate-shaped mesogenic groups 14, such as those made of triphenylene, are arranged in layers, and the rotational axes of the disc-shaped groups are largely parallel to each other. In the columnar discotic phase (see FIG. 8d), disc-shaped mesogenic groups 15 are arranged in columns, and the rotational axes of the mesogenic groups are parallel to each other.

Nematic and smectic phases may be the most suitable phases according to the present invention. FIGS. 9a through 9d show examples of advantageous smectic phases. In smectic phase s_{C} shown in FIG. 9a, the longitudinal axes of mesogenic groups 13 belonging to different layers are oriented in different directions. Smectic phase s_{A} shown in FIG. 9b differs from the one shown in FIG. 9a in that the longitudinal axes of all mesogenic groups 13 are oriented in the same direction. In smectic phase s_{B} shown in FIG. 9c, not only are the longitudinal axes of all mesogenic groups 13 oriented in the same direction, but the groups are also arranged hexagonally within their layers. This is also the case with smectic phase s_{E} shown in FIG. 9d, where, in addition, mesogenic groups 13′ are not designed more or less cylindrically, as in the other smectic phases mentioned above, but are more disc-shaped, so that the discs in each layer form two intermeshed hexagonal arrangements, and each disk in a single arrangement has four immediate neighbors that belong to the other arrangement, with the disc normals being parallel to each other within each arrangement, and the normals of both arrangements being positioned vertically relative to each other. The higher the degree of alignment, the lower the coefficient of friction in the coating during use.

Apart from applications in wiper blades, the coating according to the present invention may also be used in a rubber roll which slides along a belt and in a bearing made of plastic components.

Methods are combined to produce the coatings according to the present invention.

Molecules of a compound which contains at least one mesogenic group and one anchor group that is capable of forming a bond may be first synthesized. For each mesogenic group, a spacer may preferably be added to the end of the group facing the anchor group. It may be useful to additionally attach an end group to the end of the compound opposite the anchor group to reduce interaction between the coating and the surface (e.g., a windshield). The anchor group may be selected depending on the type of bond being intended. If the compound is to be bonded to the body by intermolecular forces, such as hydrogen bridges, the anchor group may be, for example, a carboxyl group. In such cases, the anchor group may be identical to the anchoring group (see above). If the bond is to be chemical, radical or UV radiation-initiated polymerization, polycondensation or a polymer-like reaction corresponding to these reactions or vinyl addition may be used, in particular, as reactions for forming the bond. An→Si—H group may preferably be used for vinyl addition, for example, to isoprene, as the anchor group. Alternatively, a

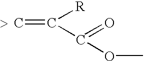

group or a >C═C<_{R} group for radical polymerization may be used as the anchor group. Alternatively, a —NH₂ group or a

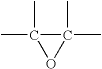

group for polycondensation may be used as the anchor group. To perform the above-mentioned reactions, the molecule with which the anchor group reacts contains a corresponding group, for example an unsaturated bond, with which the anchor group reacts for the anchoring group.

The above-mentioned compound is a source material in the production of single- and multilayer coatings. As described earlier, the selection of the anchor group may be a determining factor in planned further processing of the above-mentioned compound.

First, the production of body coatings in which the mesogenic groups are arranged in a single layer will be described. Two methods may be used for this purpose in particular.

According to the first method, a graft monomer is attached by intermolecular forces or chemical bonding to the primary chain of a polymer, which is an (initially) unattached polymer molecule or a polymer belonging to the surface of the body. A “graft monomer” in this context is a compound, like that described above, which is grafted to the primary chain of a polymer by intermolecular forces or by a chemical reaction.

The coating adhering by intermolecular forces is produced by bringing the appropriately formed anchor group of the graft monomer into contact with the primary chain of the polymer and forming, for example, a hydrogen bridge bond with it.

If the graft monomer is to form a chemical bond with the polymer, the primary group of the polymer then includes reactive groups, such as unsaturated double bonds, with which the anchor group on the graft monomer, for example a silane group, reacts, thus forming the anchoring group. The reaction yields an LC side chain polymer.

A chain monomer is used in the second method. In this context, a “chain monomer” is a compound like the one described above, whose anchor group is incorporated by polymerization as one element of the primary chain of a polymer. For example, the anchor group is made of a bivalent radical, such as an ethylene group, to which a molecule radical that contains the mesogenic group and possibly the spacer and the end group is attached as a side chain. The chain monomer or anchor group is thermally polymerized using a catalyst, such as AlBN, or by luminous radiation in the presence of a photoinitiator such as Irgacure® or Darocur® (both are products marketed under these trade names by Ciba-Geigy, Basel, Switzerland). This yields an LC side chain polymer.

The product produced in the first method by causing the graft molecule to react with an unattached polymer molecule and the LC side chain polymer product produced in the second method are bonded to the body either by intermolecular forces or by chemical cross-linking.

While the single-layer coating is particularly suitable for illustrating the coating production method, it has few practical applications (see above). Once again, there are a number of different methods for producing coatings in which the mesogenic groups are arranged in multiple layers.

One of these, whose result is illustrated in FIG. 5b, is to provide the compound with two or more consecutive mesogenic groups. To do this, monomers containing at least one mesogenic group and having reactive groups at both ends are made to react with each other, possibly with the periodic use of protective groups, thus producing graft monomers (which are then correctly termed oligomers or polymers instead of monomers) or chain monomers with two or more (oligomers) or many (polymer) mesogenic groups. The compounds thus obtained are then made to react with one mesogenic group each, like the graft monomers and chain monomers described above. Alternatively, it is possible to first produce one graft monomer or one chain monomer, each having one mesogenic group, cause it to react as described above, and then extend the side chains.

Another option—the result of which is illustrated in FIG. 5a—for producing coating with mesogenic groups arranged in more than one layer is to produce at least two types of graft monomers or chain monomers, each having one mesogenic group but spacers of different lengths, and then to cause the at least two types of compounds to react to a polymer or to each other as described above. This enables mesogenic groups in side chains that are anchored to the body or to a polymer to belong to different layers.

As an alternative to the two methods of producing coatings having mesogenic groups arranged in more than one layer, as described in the preceding sections, at least two types of graft monomers or chain monomers with variable numbers of mesogenic groups and possibly variable spacer length may be produced, and the at least two types of compounds subsequently made to react with a polymer or each other, as described above.

To arrange the mesogenic groups in multiple layers, it is also possible to stack polymers produced according to the present invention in multiple layers on the body. This variation is possible with all polymers produced as described above, i.e., including those in which the side chains are attached to the primary chain of the polymer by intermolecular forces. Adjacent stacked polymers may be bonded together by cross-linking their primary chains and possibly cross-linking the second layer with an adjacent primary chain and with the surface of the body (the result is illustrated in FIGS. 6a and 6b). A bond may also be produced by intermeshing the side chains belonging to adjacent stacked polymers like the bristles of two brushes so that they adhere to one another via intermolecular forces. For this purpose (which also requires the primary chain components to be freely rotatable around the chain axis), it is possible to incorporate the polymers in the second and subsequent layers in such a way that the side chains project from the primary chain not only in a direction extending away from the body, but also in the opposite direction (the result is illustrated in FIG. 7).

The present invention is explained in even greater detail on the basis of two exemplary embodiments.

### EXAMPLE 1

A chain monomer having structural formula (I)

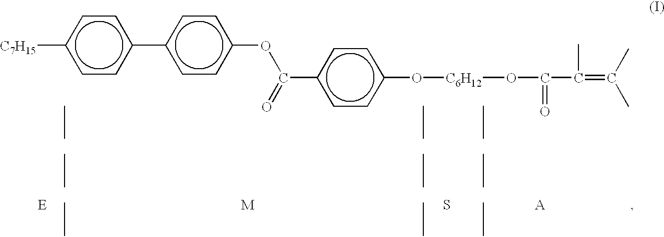

where the zones identified by E, M, S and A mark the end group, mesogenic group, spacer and anchor group, was polymerized thermally using 3 mol. % of AlBN—in relation to the total weight of the monomer and catalyst—or by a photoinitiator, such as Irgacure®. This resulted in an LC side chain polymer. The polymer thus produced was bonded with its primary chain to a body, such as a wiper blade, by cross-linking or via intermolecular forces such as hydrogen bridges. The coating thus obtained was a single-layer coating.

### EXAMPLE 2

A graft monomer having structural formula (III) was made to react with the surface of a body having unsaturated bonds, such as a wiper blade made of polybutadiene (illustrated by structure (IV)), using H₂PtCl₆ (10⁻⁶ mol. Pt/mol. of compound) as the catalyst:

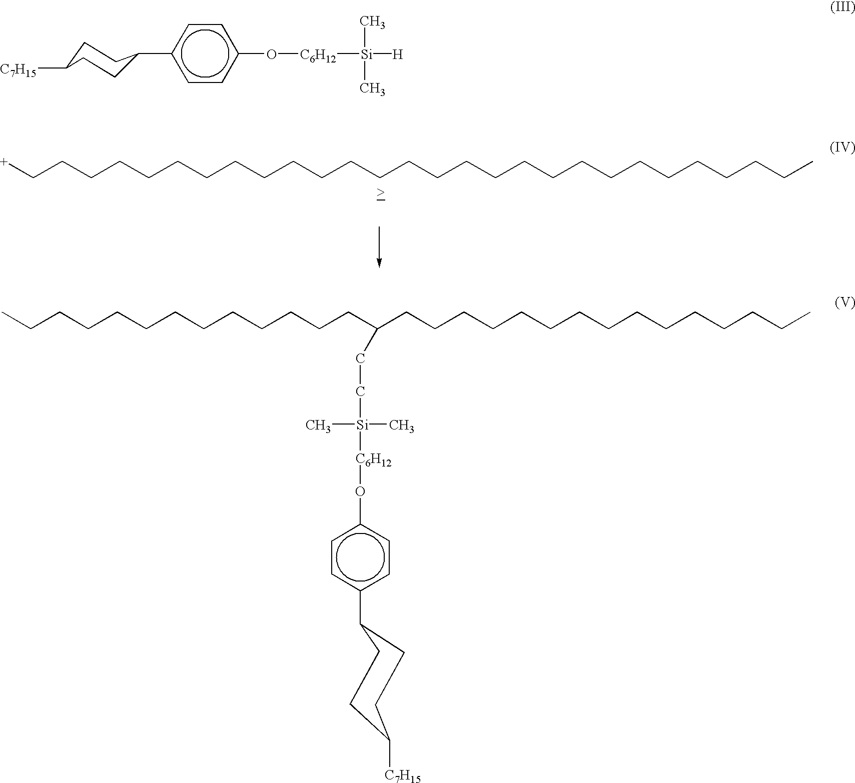

The surface was provided with superficially bonded LC elements, producing the structure illustrated by structural formula (V). The coating thus obtained was a single-layer coating.

Alternatively, the same method was used to cause the graft monomer to react with an unattached polymer molecule. This yielded an LC side chain polymer in which the graft polymer provided the side chain and the polymer the primary chain. This LC side chain polymer was then bonded to the surface of a body as described in Example 1.

What is claimed is:

1. A coating for application to a body and acting as a lubricant, wherein:
at least one surface of the body to be coated contains a polymer;
the coating is bonded to the at least one surface of the body at least by an intermolecular force; and
the coating has an LC property.

2. The coating according to claim 1, wherein a plurality of side chains, each of which includes at least one mesogenic group, extends from the at least one surface of the body.

3. The coating according to claim 2, wherein the plurality of side chains are attached to the at least one surface of the body.

4. The coating according to claim 3, wherein the plurality of side chains are attached by at least one of a chemical bonding and the intermolecular force.

5. The coating according to claim 4, wherein each of the plurality of side chains is attached via an anchoring group.

6. The coating according to claim 2, wherein:
the plurality of side chains are attached to a primary chain of a polymer molecule; and
the primary chain of the polymer molecule is attached to the at least one surface of the body.

7. The coating according to claim 6, wherein:
the plurality of side chains are attached by at least one of a chemical bonding and the intermolecular force;
the polymer molecule is attached by at least one of the chemical bonding and the intermolecular force; and
the polymer molecule is attached by intermolecular force whenever the plurality of side chains are attached by the intermolecular force.

8. The coating according to claim 7, wherein each of the plurality of side chains is attached via an anchoring group.

9. The coating according to claim 2, wherein at least one end group is attached to at least one end of at least one of the plurality of side chains, the at least one end facing away from the at least one surface of the body.

10. The coating according to claim 9, wherein the at least one end group is nonpolar.

11. The coating according to claim 10, wherein the at least one end group is an alkyl group.

12. The coating according to claim 10, wherein the at least one end group is a fluorinated alkyl group.

13. The coating according to claim 11, wherein the at least one end group is one of a C₂H₅ group, a C₇H₁₅ group, a C₈H₁₇ group, and a CF₃ group.

14. The coating according to claim 9, wherein the at least one end group is polar.

15. The coating according to claim 14, wherein the at least one end group is a CN group.

16. The coating according to claim 2, wherein:
each of the plurality of side chains is provided with a mesogenic group;
each of the plurality of side chains is attached via an anchoring group; and
a spacer is inserted at an end of the mesogenic group facing the anchoring group.

17. The coating according to claim 16, wherein the spacer is one of an alkyl group and a siloxane group.

18. The coating according to claim 16, wherein the plurality of side chains form one of an LC primary chain oligomer and an LC primary chain polymer.

19. The coating according to claim 16, wherein:
at least two embodiments of the plurality of side chains are present;
each of the at least two embodiments has a different number of mesogenic groups; and
each of the at least two embodiments has a different spacer length.

20. The coating according to claim 2, wherein:
at least two mesogenic groups arranged consecutively with respect to an anchoring group are provided per side chain; and
a first spacer is provided between the anchoring group and a nearest mesogenic group.

21. The coating according to claim 20, wherein a second spacer is provided between the at least two mesogenic groups.

22. The coating according to claim 20, wherein the first spacer is one of an alkyl group and a siloxane group.

23. The coating according to claim 21, wherein the second spacer is one of an alkyl group and a siloxane group.

24. The coating according to claim 20, wherein the plurality of side chains form one of an LC primary chain oligomer and an LC primary chain polymer.

25. The coating according to claim 20, wherein:
at least two embodiments of the plurality of side chains are present;
each of the at least two embodiments has a different number of mesogenic groups; and
each of the at least two embodiments has a different spacer length.

26. The coating according to claim 2, wherein the at least one mesogenic group is selected from the group consisting of biphenyl, hydrobenzoate, naphthalene derivative, and triphenylene.

27. The coating according to claim 2, wherein a plurality of bonded-together layers of the coating are positioned on the body.

28. The coating according to claim 27, wherein adjacent layers of the plurality of bonded-together layers are bonded together by one of:
cross-linking their primary chains; and
cross-linking a second layer with an adjacent primary chain and with the body.

29. The coating according to claim 27, wherein, for a second layer and for subsequent layers, each of the plurality of side chains project from a primary chain in one of a direction tending away from the body and a direction tending towards the body.

30. The coating according to claim 29, wherein:
each of the plurality of side chains belonging to adjacent layers of the plurality of bonded-together layers are intermeshed as a plurality of bristles of two opposingly arranged brushes; and
each of the plurality of side chains belonging to adjacent layers that are intermeshed adhere to one another by intermolecular forces.

31. The coating according to claim 1, wherein at least one mesogenic group forms an LC phase, the LC phase selected from the group consisting of nematic, smectic, discoid nematic and columnar discotic phases.

32. The coating according to claim 31, wherein the at least one mesogenic group forms at least one of a nematic LC phase and a smectic LC phase.

33. The coating according to claim 32, wherein:
the at least one mesogenic group forms a smectic LC phase; and
the smectic LC phase is selected from the group consisting of a smectic S_{A} phase, a smectic S_{B} phase, a smectic S_{C} phase, and a smectic S_{E} phase.

34. The coating according to claim 1, wherein the polymer is elastic.

35. The coating according to claim 34, wherein the body is a windshield wiper blade.

36. A method for producing a coating of a body, the coating acting as a lubricant and having LC properties, the method comprising:
producing a compound that includes at least one mesogenic group; and
bonding, one of directly and via a primary chain of a polymer, a plurality of molecules of the compound at least partially to at least one surface of the body;
wherein the at least one coated surface of the body contains the polymer.

37. The method according to claim 36, wherein:
each of the plurality of molecules of the compound includes an anchor group; and
the step of bonding is performed via the anchor group to the at least one coated surface of the body.

38. The method according to claim 37, wherein the step of producing the compound includes grafting at least one graft monomer to the polymer by the anchor group.

39. The method according to claim 38, wherein the step of grafting includes one of:
making the anchor group adhere to the polymer by an intermolecular force to form an LC side chain polymer; and
reacting the anchor group with a reactive group on the polymer to form the LC side chain polymer.

40. The method according to claim 37, wherein:
the step of producing the compound includes producing a plurality of chain monomers, each chain monomer having a bivalent radical as the anchor group; and
the step of bonding includes polymerizing the bivalent radical to form an LC side chain polymer.

41. The method according to claim 38, wherein if the step of grafting includes a chemical reaction, then polymerization involves one of:
one of radical polymerization and radiation-initiated polymerization, the anchor group being at least one of a 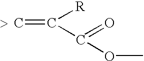
group and a >C═C<_{R} group;
polycondensation, the anchor group being one of a —NH₂ group and a 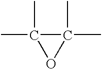
group;
a polymer-like reaction corresponding to one of radical polymerization, radiation-initiated polymerization, and polycondensation; and
vinyl addition, the anchor group being a —→Si—H group, wherein with the reactive group on a primary chain preferably being a >C═C< group reacting with the primary chain.

42. The method according to claim 38, wherein, if a resulting polymer is not part of the at least one coated surface of the body, the resulting polymer is made to react with the at least one coated surface of the body so that a plurality of side chains extend from the at least one coated surface of the body.

43. The method according to claim 42, wherein the primary chain of the resulting polymer is at least one of cross-linked with the body and made to adhere to the body by the intermolecular force.

44. The method according to claim 37, wherein an end group is attached to an end of the compound facing away from the anchor group.

45. The method according to claim 37, wherein:
the compound contains a mesogenic group; and
a spacer is incorporated into one of an end of the mesogenic group facing the anchor group and adjacent to an end of the mesogenic group facing the anchor group.

46. The method according to claim 37, further comprising:
incorporating at least two mesogenic groups arranged consecutively from the perspective of the anchor group into the compound; and
providing one of:
a first spacer between the anchor group and a closest mesogenic group, and
a second spacer between the at least two mesogenic groups.

47. The method according to claim 46, wherein the plurality of molecules of the compound are designed as one of an LC primary chain oligomers and an LC primary chain polymer.

48. The method according to claim 45, wherein:
at least two embodiments of the plurality of molecules of the compound are produced;
each of the at least two embodiments has a different number of mesogenic groups;
each of the at least two embodiments has a different spacer length;
each of the at least two embodiments uses protective groups; and
the at least two embodiments are bonded to the at least one coated surface of the body one of directly and via the primary chain of the polymer;
wherein the at least two embodiments are one of statistically and regularly distributed.

49. The method according to claim 36, wherein a plurality of layers of a produced polymer is deposited on the at least one coated surface of the body, each of the plurality of layers deposited over another of the plurality of layers.

50. The method according to claim 49, wherein each of the plurality of layers is bonded to an adjacent layer of each of the plurality of layers by one of:
cross-linking a first primary chain of each of the plurality of layers and an adjacent primary chain of the adjacent layer; and
cross-linking a second layer with the adjacent primary chain and with the at least one coated surface of the body.

51. The method according to claim 49, wherein:
a plurality of side chains include a first plurality of side chains and a second plurality of side chains; and
a second layer and each subsequent layer of the plurality of layers incorporate the polymer so that the first plurality of side chains project from the primary chain in a direction tending away from the body and the second plurality of side chains project from the primary chain in a direction tending towards the body.

52. The method according to claim 51, wherein:
each of the plurality of side chains belonging to adjacent layers of the plurality of layers are intermeshed as a plurality of bristles of two opposingly arranged brushes; and
each of the plurality of side chains belonging to adjacent layers that are intermeshed adhere to one another by the intermolecular force.
